(19) United States
(12) Patent Application Publication
(10) Pub. No.: US 2020/0256648 A1
(43) Pub. Date: Aug. 13, 2020

(54) PROTECTION APPARATUS FOR A VEHICLE

(71) Applicant: Cronjé Venter, Phalaborwa (ZA)

(72) Inventor: Cronjé Venter, Phalaborwa (ZA)

(21) Appl. No.: 16/462,088

(22) PCT Filed: Aug. 8, 2017
(86) PCT No.: PCT/IB2017/054832

§ 371 Date: May 17, 2019

(30) Foreign Application Priority Data
Nov. 18, 2016 (ZA) 2016/07983

(51) Int. Cl. F41H 7/04; B60R 21/12

(52) U.S. Cl. CPC F41H 7/044; B60R 21/12

(57) ABSTRACT

The invention discloses a protection apparatus for a vehicle comprising a plurality of interconnected elongate supporting members defining a frame, wherein at least one of the supporting members is movably securable between a first position and an extended position such that the supporting members operatively abut an interior of the vehicle to secure the apparatus inside the vehicle. The supporting members are configured to receive a ballistic protective material to operatively span across at least a portion of the frame.

### FIELD OF THE INVENTION

This invention relates to a protection apparatus, more particularly to a protection apparatus for a vehicle which provides ballistic protection to an occupant in and contents of the vehicle.

### BACKGROUND OF THE INVENTION

The concept and method of retrofitting standard vehicles to provide protection to its occupants and contents thereof are known in the art. Conventionally, laminated break-in resistant windows are fitted within a standard vehicle's original window frames, or laminated sheets are installed onto existing windows of the vehicle.

In addition, prefabricated rigidly formed lightweight opaque armour is moulded to closely fit within the standard vehicle. The armour is designed for on-site manufacture of components and installation procedures to produce a lightweight armoured vehicle.

The aforementioned apparatuses only provide limited protection, for example against breakage of windows, in an effort to prevent theft from the vehicle (sometimes referred to as “smash-and-grab” protection). However, these known apparatuses do not provide adequate protection against ballistic threats for example from firearms.

For ballistic protection, the most prevalent method of “armouring” a standard vehicle is by adding steel plate components to the vehicle (where opaque armour is appropriate) and replacing standard window frames with larger window frames and either providing thicker glass window or adding thick laminated transparent, translucent or opaque armour material within the enlarged window frames. A disadvantage of these retrofitted armoured vehicles is that they are heavy, expensive to manufacture and maintain; and they have limited manoeuvrability. Furthermore, the aforementioned fitted components make these armoured vehicles easily identifiable making them targets to would-be thieves.

PCT application no. WO 1994/029665 discloses an improved lightweight armoured vehicle and method of retrofitting standard vehicles to make them lightweight armoured vehicles. This includes fitting metal caps directly on laminated windows to protect the laminated edges of the windows from stress, moisture and atmosphere. Prefabricated rigidly formed lightweight opaque armour is also moulded to closely fit within the vehicle.

Another example of a known apparatus is United States patent application no. U.S. Pat. No. 5,811,719 which provides a removable flexible curtain made of layers of fibrous material secured directly onto the door of a vehicle.

Disadvantages associated with these known apparatuses include their prohibitively expensive nature and the generally time-consuming and inefficient installation procedures. A further disadvantage is that most, if not all known apparatuses result in a permanent fixture on the vehicle. A yet further disadvantage of known apparatuses is that the vehicle itself is permanently modified and the structural integrity of the vehicle is altered and/or compromised upon installation of the protection apparatus. Even if these devices are said to be removable, removal thereof is labour intensive and time consuming and nonetheless has an impact on the structural integrity of the vehicle.

The abovementioned disadvantages of these apparatuses are accordingly prohibitive to most vehicle owners leaving them exposed to danger.

### Object of Invention

It is accordingly an object of the present invention to provide a protection apparatus for a vehicle with which the above disadvantages could at least partially be overcome or alleviated and/or to provide a useful alternative to the known protection apparatuses.

### SUMMARY OF THE INVENTION

In accordance with a first aspect of the invention there is provided a protection apparatus for a vehicle comprising a plurality of interconnected elongate supporting members defining a frame, wherein at least one of the supporting members is movably securable between a first position and an extended position such that the supporting members operatively abut an interior of the vehicle to secure the apparatus inside the vehicle; and wherein the supporting members are configured to receive ballistic protective material to operatively span across at least a portion of the frame.

The invention further provides for the movable supporting members to be biased to the extended position.

A further aspect of the invention provides for the ballistic protective material to be a flexible material which is displaceable between a stored and a deployed position on the frame. The ballistic protective material may further include deployment means, such as a pressurized coil extension, to bias the material to the deployed position. The ballistic protective material may yet further include retraction means, such as a pressurized coil retractor, to bias the material to the stored position.

The protective material may include layers of any one or more of a para-aramid synthetic fibre (such as Kevlar®) and graphene or a combination thereof.

There is yet further provided for the supporting members to provide a measure of ballistic protection which is at least equivalent to that of the ballistic protective material. The supporting members may for example comprise hollow aluminium or carbon fibre tubes having para-aramid synthetic fibre and/or graphene reinforced composite layers.

A yet further feature of the invention provides for the weight bearing capacity of the supporting members to be sufficient to support the weight of the protective material.

A yet further feature of the invention provides for the movement of the at least one of the supporting members between the first position and the extended position to be a telescopic movement.

In accordance with a further aspect of the invention, there is provided for the frame to operatively define at least two horizontal levels for the ballistic protective material to span between the respective levels.

In accordance with a second aspect of the invention there is provided a kit for retrofitting a protection apparatus in a vehicle, comprising the apparatus and flexible material as defined above.

### BRIEF DESCRIPTION OF THE ACCOMPANYING DIAGRAMS

The invention will now further be described, by way of example only, with reference to the accompanying diagrams wherein:

FIG. 1 is a top perspective view of a frame of a protection apparatus for a vehicle in accordance with the invention;

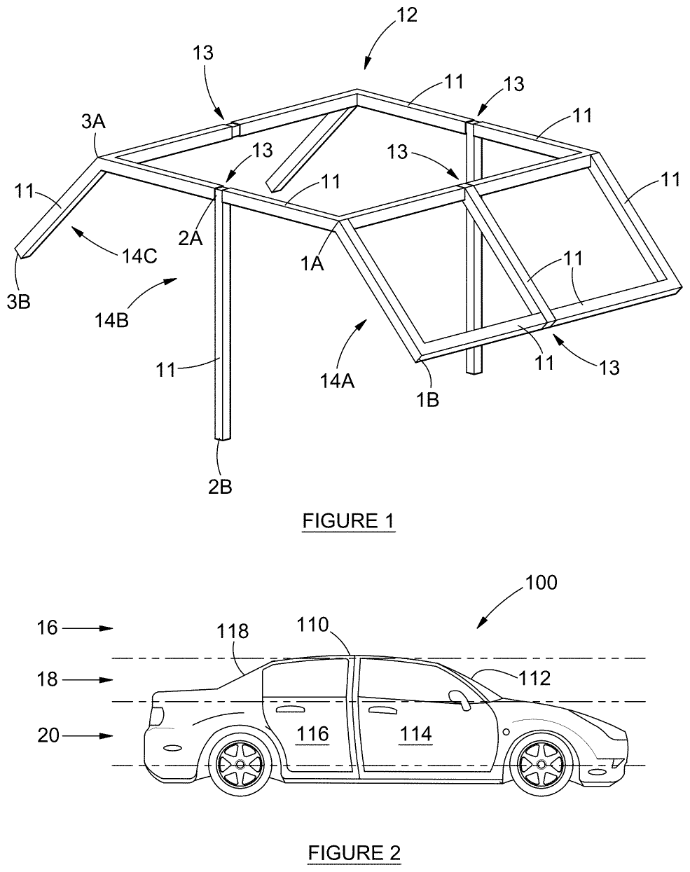

FIG. 2 is a schematic side view of a vehicle defining various levels; and

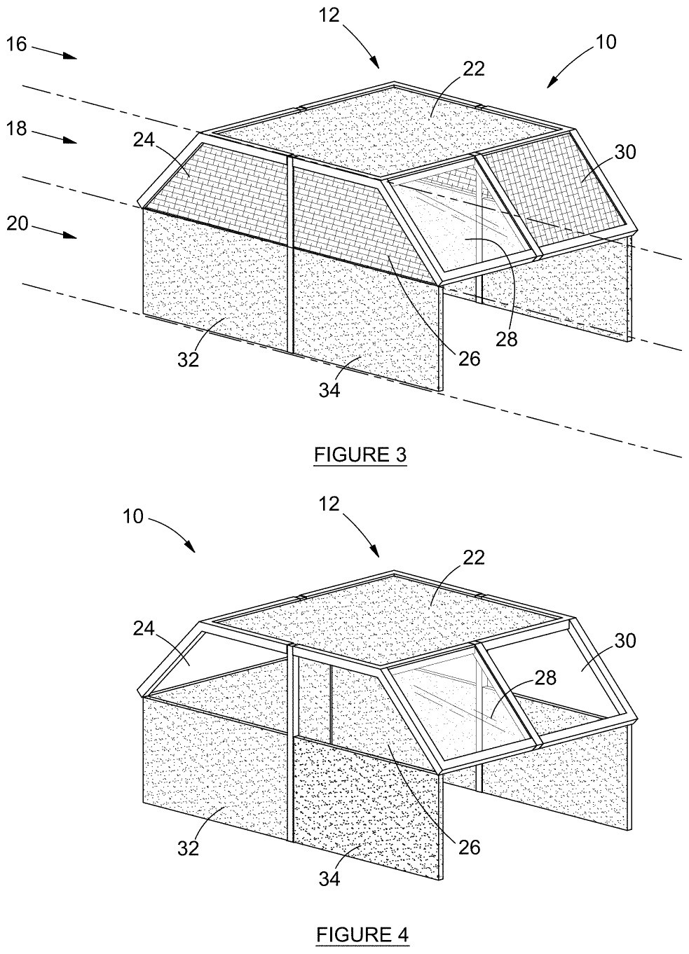

FIGS. 3 & 4 are perspective views of the protection apparatus including flexible protective ballistic material installed thereon.

### DESCRIPTION OF A PREFERRED EMBODIMENT OF THE INVENTION

A protection apparatus for a vehicle is generally designed by reference numeral in the drawings.

As shown, a protection apparatus 10 for a vehicle 100 comprises a plurality of interconnected elongate supporting members 11 defining a frame 12 which is retro-fittable inside the vehicle 100. At least one of the supporting members 11 is movably securable between a first position and an extended position such that the supporting members 11 operatively abut an interior of the vehicle 100 to secure the apparatus 10 inside the vehicle.

The supporting members 11 are configured to receive a ballistic protective material 22, 24, 26, 28, 30, 32, 34 (shown in FIGS. 3 and 4) to operatively span across at least a portion of the frame 12.

The supporting members 11 are of variable lengths according to their respective positions in the frame 12. At least some of the supporting members 11 are movably securable relative to their respective adjacent supporting members 11 between the first position and the extended position. In the first position, the overall length of the supporting members 11 is shorter compared to their respective lengths when in the extended position. This enables the supporting members 11, when in the extended position, to operatively abut an interior of the vehicle 100 such that the frame 12 is fitted and secured inside the vehicle. In this embodiment, the supporting members 11 are configured in a manner to allow telescopic movement of the supporting members 11 at telescopic locations 13 between the aforementioned positions. It will be io understood that any other means of extending the length and securing the supporting members 11 in the first and extended positions may be employed without departing from the scope of the invention.

The frame 12 is configured to receive ballistic protective material 22, 24, 26, 28, 30, 32, 34 to operatively span across any portion of the frame 12 as will be explained in more detail below.

Referring to FIGS. 1 and 2, there is shown an example embodiment of the protection apparatus 10 wherein some of the supporting members 11 are configured to form first, second and third pillars 14A, 14B & 14C, the ends and/or sides and/or outer peripheries of which are configured to abut various portions of the vehicle 100 (shown in FIG. 2), which portions are inside the vehicle. Portion 1A of the first and front right pillar 14A is operatively located proximate a roof 110 of the vehicle 100, whereas a bottom front right distal end 1B of the pillar 14A is installed proximate a front windscreen 112 of the vehicle 100. The second and centre pillar 14B extends from a portion 2A thereof, proximate the roof 110 of the vehicle 100, between a front door 114 and a rear door 116 of the vehicle 100. A distal end 2B of centre pillar 14B operatively abuts a floor of the vehicle 100, also between the front and rear doors.

The third and rear right pillar 14C extends from a portion 3A thereof proximate the roof 110 of the vehicle 100 to its distal end 3B which operatively abuts the vehicle proximate a rear windscreen 118. As is evident from FIG. 1, the left-hand side of the frame 12 (when viewed from the inside of the frame 12) is of the same construction having further pillars similar to first, second and third pillars (14A, 14B and 14C) respectively, to abut the corresponding components of the vehicle on its left-hand side. Any one or more of these support members/pillars may include means for varying the operative length thereof as described above such that the distal ends, and/or sides and/or outer peripheries exert a force of sufficient degree onto the respective components of the vehicle 100 to thereby secure the frame 12 inside the vehicle. The supporting members 11 of the frame 12 which are movable as described may further include biasing means (not shown) which operatively biases the supporting members 11 to the extended position, telescopically or otherwise.

The number of centre support pillars 14B may for example be varied depending on the length of the vehicle 100 and the ability of the frame 12 to bear the weight of the ballistic protective material. The invention is therefore useful in small and large vehicles. One or more of the pillars 14A, 14B, 14C or supporting elements 11 may also be omitted if required.

The protection apparatus provides for protection on a number of horizontal levels associated with the vehicle 100. FIG. 2 shows the vehicle having an upper or headlining level 16, a middle level 18 and a lower level 20 defined.

As shown in FIG. 3, to provide protection at the headlining level 16, provision is made for ballistic protective material to span across and along the supporting members 11 to form a ballistic protective upper or headlining area 22. This area 22 provides ballistic protection from a direction above the vehicle.

Turning to the middle level 18, provision is made for flexible ballistic protective material being attached to the frame 12 to create transverse ballistic protective areas 24, 26, 28 and 30.

The lower level 20, may similarly include ballistic protective material to span across areas 32 and 34. This ballistic material is applied throughout the lower level 20, yet should still allow for normal application such as the opening of doors during normal operation.

It will be noted that similar areas are formed on the left-hand and back side of the vehicle, but are not shown and/or labelled in the drawings for the sake of brevity. It will also be understood that the frame 12 can be extended to provide a ballistic protective area at the lower level 20 next to area 34 and directly below areas 28 and 30, to provide protection to an occupant's lower body from the operative front of the vehicle.

The invention therefore provides a protection apparatus 10 which is conveniently retro-fitted into a wide array of vehicles. More particularly, the protection apparatus is fitted inside the vehicle's passenger compartment and not to the vehicle frame or other components itself. The protection apparatus is therefore visible from inside the passenger compartment.

As shown in FIG. 4 used as example of the versatility of the invention, the flexible ballistic protective material is retracted upwards and retained in a stored position. In this instance, no ballistic protection will be available to the occupant of the vehicle in areas 24, 26 and 30 when the ballistic protective material is in the stored position. In this respect, the ballistic material is still installed onto the particular support members 11, but retracted if the occupant wishes to do so. In accordance with another aspect of the invention, it is possible that the flexible material or supporting members 11 may be configured to include deployment means, such as a pressurized coil extension (not shown) so that the flexible material is biased to the deployed position. In this instance, the occupant may have the particular region open (i.e. with the material in stored position), but as soon as he suspects dangerous circumstances, he may simply actuate the pressurized coil extension or any other suitable mechanism to rapidly deploy the protective material to provide the necessary protection. It will be appreciated that the protective material may also be deployed by simply allowing the material to drop by gravity and securing the material to any one of the operatively lower supporting members 11. The protective material may also be permanently fixed to the frame 12 where appropriate, for example in the lower level 20.

In an alternative embodiment, the ballistic protective material includes retraction means, such as a pressurized coil retractor (not shown), to bias the material to the stored position. In this instance, the ballistic protective material will normally be secured in the deployed position and retracted to the stored position upon actuating the pressurized coil retractor.

It will be understood that the ballistic material may be installed in any convenient matter onto the frame 12 without departing from the scope of the invention.

The ballistic protective material may also be of any suitable kind, such as a composite of a para-aramid synthetic fibre (such as Kevlar®) and graphene. The protective material may also be reinforced in any suitable manner, for instance with energy absorbing rigid supports disposed along the protective material.

The protective material may also be transparent, translucent or opaque. In this instance, transparent protective material will typically be provided, for instance at area 28 for a right-hand drive vehicle to allow proper sight of vision for the driver of the vehicle. The protective material is preferably a material that is resistant to bullets, shrapnel or other dangerous ballistic projectiles.

It will also be understood that the term vehicle used herein may include any land, rail, air or waterborne vehicles. Even though the embodiment of the frame 12 shown in FIGS. 1, 3 and 4 is in the form of a frame for a sedan-type vehicle 100, the frame 12 and the protection apparatus 10 including the protective material may be modified to suit other types of vehicles (not shown) without departing from the spirit and scope herein. Furthermore, the supporting members 11 are telescopically movable at telescopic locations 13 as shown in FIGS. 1 and 2, however other movement locations (or other non-telescopic movement means) for the supporting members 11 may be provided as necessary, depending on the particular application or type of vehicle to be protected. For instance, telescopic locations 13 may be provided between the proximal ends (1A, 2A, 3A) and distal ends (1B, 2B, 3B) of the pillars (14A, 14B, 14C) respectively.

It is accordingly asserted that the disadvantages of the prior art are avoided, or at least alleviated by provision of the invention by providing a protective apparatus to a vehicle which is easily installable and retrofittable into a vehicle and which is non-intrusive to and therefore not affecting the structural integrity of the vehicle. Installation thereof are therefore convenient and does not require any use of tools or particular skill. The installation of the protective apparatus is also not necessarily visible, or at least not glaringly apparent from the outside of the vehicle, thereby not attracting too much attention from the outside. The invention also provides versatility in that the material may be installed in various areas of the vehicle and further provides non-permanent areas of protection which allows rapid deployment in said areas as and when required.

It will be appreciated that in terms of the invention, variations in details are possible without departing from the scope thereof.

The description herein below is presented in the cause of providing what is believed to be the most useful and readily understandable description of the principles and conceptual aspects of the invention. In this regard, no attempt is made to show structural details of the invention in more detail than is necessary for a fundamental understanding of the invention. The words used here should be interpreted as words of description rather than words of limitation.

1. A protection apparatus for a vehicle comprising:
a plurality of interconnected elongate supporting members defining a frame,
wherein at least one supporting member of the plurality of supporting members is movably securable relative to a respective adjacent supporting member between a first position and an extended position such that the plurality of supporting members operatively abut an interior of the vehicle to secure the protection apparatus inside the vehicle, and
wherein the plurality of supporting members are configured to receive a ballistic protective material to operatively span across at least a portion of the frame.

2. The protection apparatus of claim 1, wherein the at least one supporting member is operatively biased to the extended position.

3. The protection apparatus of claim 1, wherein the ballistic protective material is a flexible material, and wherein the ballistic protective material is displaceable between a stored and a deployed position on the frame.

4. The protection apparatus of claim 3, wherein the ballistic protective material further comprises a deployment means to bias the ballistic protective material to the deployed position.

5. The protection apparatus of claim 4, wherein the deployment means comprises a pressurized coil extension.

6. The protection apparatus of claim 3, wherein the ballistic protective material further comprises a retraction means to bias the ballistic protective material to the stored position.

7. The protection apparatus of claim 6, wherein the retraction means comprises a pressurized coil retractor.

8. The protection apparatus of claim 1, wherein the ballistic protective material comprises layers of one or more of a para-aramid synthetic fibre and graphene or a combination thereof.

9. The protection apparatus of claim 1, wherein the plurality of supporting members provide ballistic protection, and wherein the ballistic protection which is at least equivalent to that of the ballistic protective material.

10. The protection apparatus of claim 9, wherein the plurality of supporting members comprise hollow aluminium or carbon fibre tubes having para-aramid synthetic fibre or graphene reinforced composite layers.

11. The protection apparatus of claim 1, wherein the weight bearing capacity of the plurality of supporting members is sufficient to support the weight of the ballistic protective material.

12. The protection apparatus of claim 1, wherein a movement of the at least one supporting member of the plurality of supporting members between the first position and the extended position comprises a telescopic movement.

13. The protection apparatus of claim 1, wherein the frame operatively defines at least two horizontal levels.

14. A kit for retrofitting a protection apparatus in a vehicle, comprising:
a plurality of interconnected elongate supporting members defining a frame, and
a ballistic protective material operatively spanning across at least a portion of the frame,
wherein at least one supporting member of the plurality of supporting members is movably securable relative to a respective adjacent supporting member between a first position and an extended position, such that the plurality of supporting members operatively abut an interior of the vehicle to secure the protection apparatus inside the vehicle, and
wherein the ballistic protective material is displaceable between a stored and a deployed position on the frame.

15. (canceled)

16. (canceled)

17. The protection apparatus of claim 13, wherein the ballistic protective material spans between the respective levels of the at least two horizontal levels.

18. The kit of claim 14, wherein the ballistic protective material further comprises a deployment means to bias the ballistic protective material to the deployed position.

19. The kit of claim 14, wherein the ballistic protective material comprises layers of a para-aramid synthetic fibre or graphene or a combination thereof.

20. The kit of claim 14, wherein the plurality of supporting members comprise hollow aluminium or carbon fibre tubes.

21. The kit of claim 20, wherein the plurality of supporting members comprise composite para-aramid synthetic fibre or graphene reinforced composite layers.
